(19) United States
(12) Patent Application Publication
(10) Pub. No.: US 2013/0240585 A1
(43) Pub. Date: Sep. 19, 2013

(54) Carrier for a Motorcycle

(71) Applicant: Bergeron Dennis, Delta (CA)

(72) Inventor: Bergeron Dennis, Delta (CA)

(21) Appl. No.: 13/607,506

(22) Filed: Sep. 7, 2012

Related U.S. Application Data
(60) Provisional application No. 61/531,751, filed on Sep. 7, 2011.

(51) Int. Cl. B62J 7/04; B23P 19/00

(52) U.S. Cl. CPC B62J 7/04; B23P 19/00
USPC 224/423; 29/428

(57) ABSTRACT

A golf club carrier for a motorcycle which includes a frame with a front and a back, a top and a bottom. Two vertical supports provided as the back. The vertical supports each have a first end and a second end. A horizontal support extends perpendicular from the second end of the vertical supports. A mounting means is provided for mounting the horizontal support to a rear of a motorcycle body. A golf club bag support platform extends outwardly from the second end of the vertical support and over the horizontal support. A securing means is provided for securing a golf club bag within the frame. A cross support member is secured to the golf club bag support platform and as well as being secured to and traversing the horizontal support.

### CROSS-REFERENCE TO RELATED APPLICATIONS

This application claims priority to co-pending U.S. Provisional Application Ser. No. 61/531,751 entitled “Carrier for a Motorcyle”, filed Sep. 7, 2011 and is expressly incorporated by reference in its entirety.

### FIELD

This invention relates to the field of carriers for motorcycle.

### BACKGROUND

Motorcycles represent a convenient and easy form of transportation for one or two people. While convenient, the drawback to motorcycle transportation is that there are limitations on the amount and type of cargo that can be carried on a motorcycle. Some types of suitcases and carry-on luggage have been adapted to fit onto the sides of the motorcycle frame, however suitcases can only contain items of a size and volume limited to the size of the suitcase. Occasionally, trailers are hitched to the motorcycle to tow larger cargo, however trailers are vulnerable to theft and cause a drag on the mobility of a motorcycle. The swaying motion can also cause unexpected disruptions in balance. Moreover, when one or more riders wish to transport golf clubs or an item of similar dimensions, the options are limited. There are some golf club carriers which mount to the side of the frame of the motorcycle but these types of devices cause the driver to have to compensate for the weight imbalance that occurs when the golf club bag is carried on the side of the motorcycle. Mounting a golf club bag on the side also interferes with the ability to carry passengers or other types of cargo. Finally, such carriers are limited to carrying one golf club bag at a time. What is required is a form of carrier which can carry one or two golf club bags, or similar items, without compromising the balance of the motorcycle.

### SUMMARY

There is provided a golf club carrier for a motorcycle which includes a frame that has a front and a back, a top and a bottom. Two vertical supports are provided as the back. The vertical supports each have a first upper end and a second lower end. A horizontal support extends perpendicular from the second lower end of the vertical supports. A mounting means is provided for mounting the horizontal support to a rear of a motorcycle body. A golf club bag support platform extends outwardly from the second end of the vertical support and over the horizontal support. A securing means is provided for securing one or more golf club bags within the frame. A cross support member is secured to the golf club bag support platform and as well as being secured to and traversing the horizontal support.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a golf club carrier for a motorcycle.

FIG. 2 is a top plan view of the golf club carrier illustrated in FIG. 1.

FIG. 3 is a side elevation view of the golf club carrier illustrated in FIG. 1.

FIG. 4 is a front elevation of the golf club carrier illustrated in FIG. 1 carrying a golf club bag.

FIG. 5 is a side elevation view of the golf club carrier mounted on a motorcycle.

FIG. 6 is a perspective view of a second embodiment of the golf club carrier for a motorcycle configured for carrying two golf club bags.

FIG. 7 is a rear view of the golf club carrier illustrated in FIG. 6 carrying two golf club bags.

### DETAILED DESCRIPTION

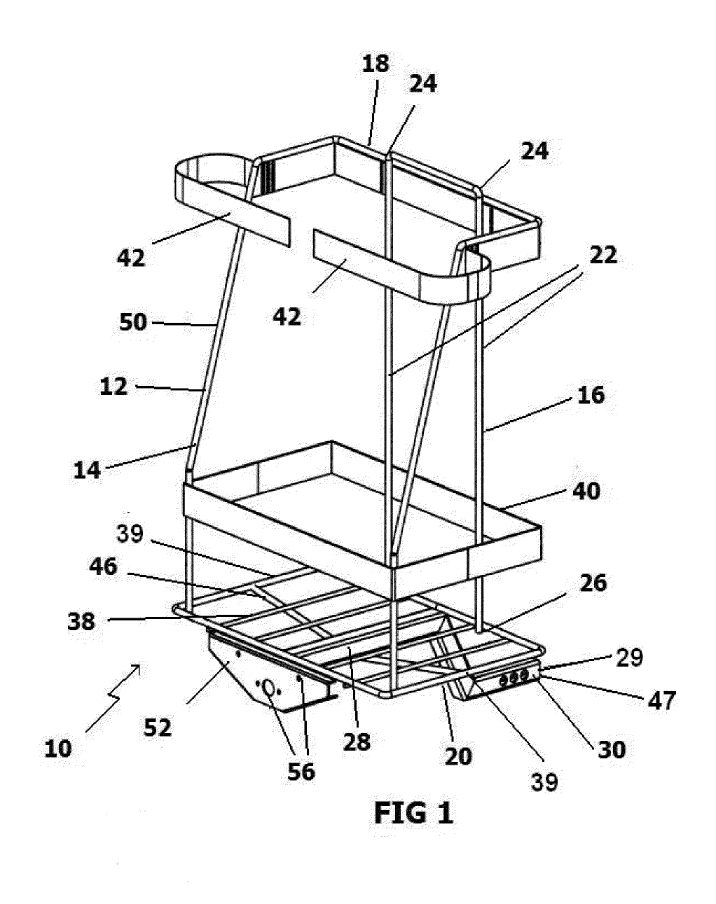

A golf club carrier for a motorcycle generally identified by reference numeral 10, will now be described with reference to FIG. 1 through 7.

### Structure and Relationship of Parts:

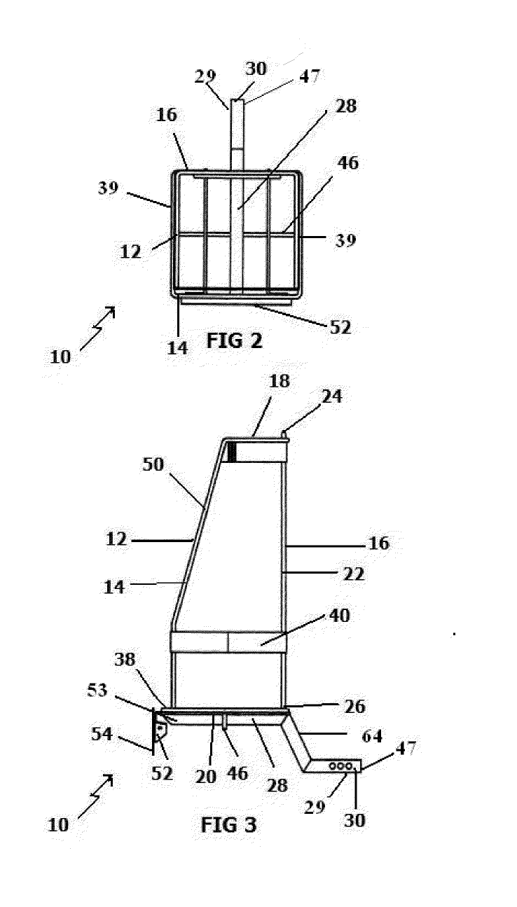

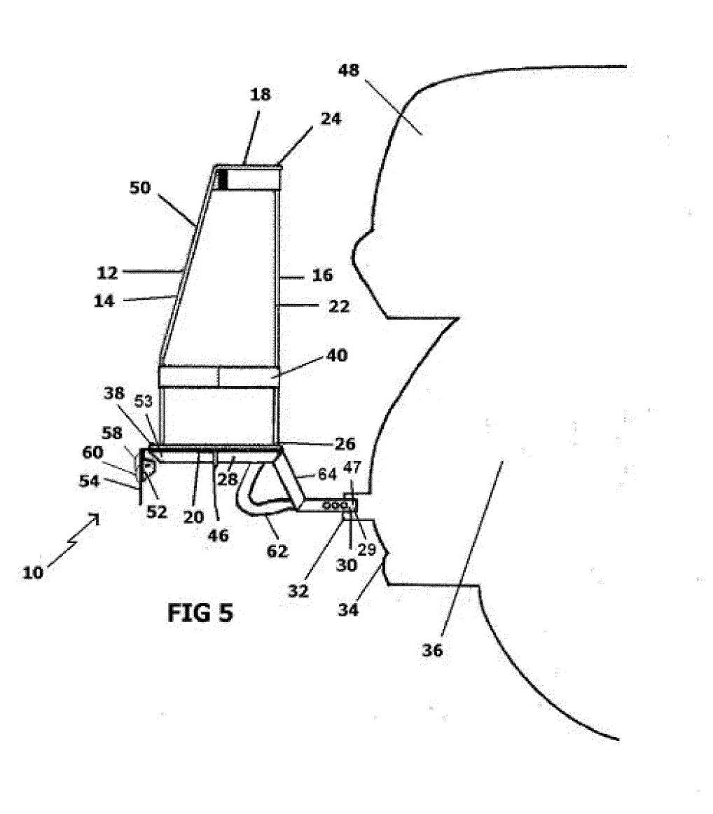

Referring to FIG. 1, here is illustrated a golf club carrier for a motorcycle 10 which includes a frame 12 that has a front 14, a back 16, a top end 18 and bottom end 20. Top end 18 is open. Two vertical supports 22 are provided on the back 16. The vertical supports 22 each have a first upper end 24 and a second lower end 26. A horizontal support 28 extends along the bottom end 20 of golf club carrier 10 perpendicular to the second end 26 of the vertical supports 22. Referring to FIG. 2, a mounting means 29 in the form of a hitch 30 is provided for mounting the horizontal support 28 to a hitch receiver 32 provided on a rear 34 of a motorcycle body 36 as shown in FIG. 5. It will be appreciated and understood that there are differing types of mounting means, including various known hitching mechanisms, which could be used to secure golf club carrier 10 to the motorcycle body 36.

Referring again to FIG. 1, a golf club bag support platform 38 extends outwardly from the second end 26 of the vertical supports 22 and over the horizontal support 28. The golf club bag support platform 38 is substantially planer, and has opposed sides 39. Opposed sides 39 can be provided with an upwardly extending lip (not shown) to prevent contents from sliding during use. In the illustrated embodiment, golf club bag support platform 38 is mounted to the horizontal support 28 such that the horizontal support 28 centrally located and is equidistant from either of opposed sides 39 of the golf club bag support platform 38. Golf club bag support platform 38 can be of many configurations including a flat panel, perforated panel, or cross hatched metal. It fabricated from intersecting wire, cable, fabric straps or other materials if desired. A textured coating can be applied to prevent slippage of contents.

Referring again to FIG. 1, a first securing means in the form of a metal band 40 and a second securing means in the form of polypropylene straps 42 are provided on the front 14 of frame 12 for securing one or more golf club bags 44 within the frame 12. Straps 42 should be used to restrain golf club bags 44 securely within frame 12 such that golf club bags 44 do not shift or slide around during transportation. It will be appreciated that there are other types of devices are known that can also be used to secure golf club bag 44 within frame 12 including but not limited to bungee cords, elastic bands, and mating tape closing straps.

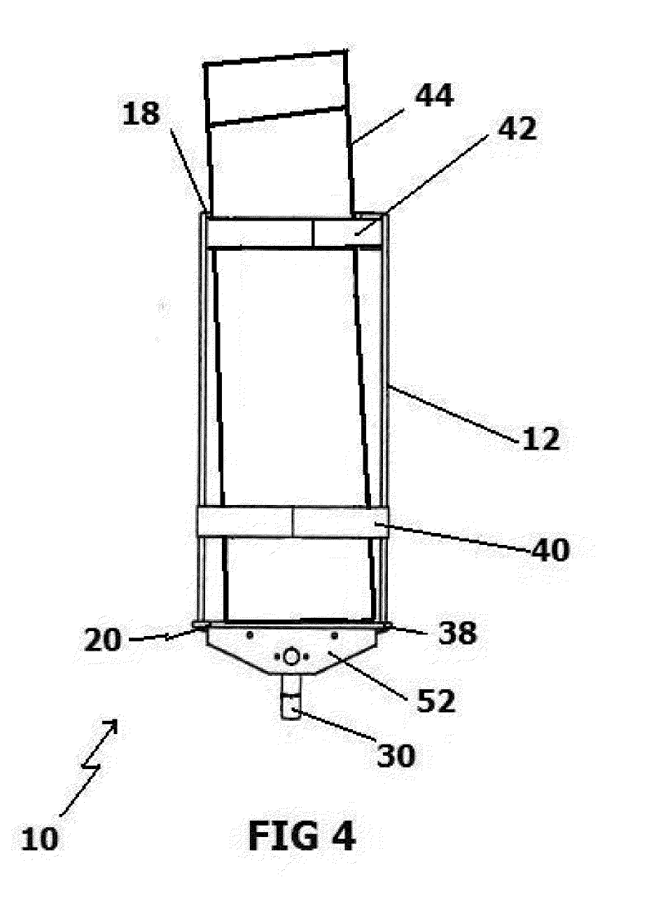

A cross support member 46 is secured to the golf club bag support platform 38 at opposed sides 39 as well as being secured to and traversing the horizontal support 28. Referring to FIG. 4, cross support member 46 provides the necessary stability to the carrier 10 for maintaining golf club bag 44 in an upright and balanced position on the motorcycle 36. Any changes in balance or direction of the motorcycle 36 are transmitted through the cross support member 46 to the horizontal support 28 so that the carrier 10 moves the same manner as the motorcycle 36 minimizing any unexpected shifts in load or balance. The operator of the motorcycle 36 should have minimal compensation adjustments to make in his riding style despite having added cargo and weight being carried by his motorcycle 36. It will be appreciated that there can be one or more cross support members 46, however they must positioned so as to transmit the vertical load from the golf club bag support platform 38 to the horizontal support bar 28 for stability. The horizontal support 28 and cross support member 46 must have sufficient strength and stiffness to meet this criteria. As motorcycles 36 have two wheels in alignment, they do not have the stabilizing wheel base that four wheel cars and trucks have, as such small variations in weight and movement cause a motorcycle to destabilize and require an operator to adjust his riding style to compensate.

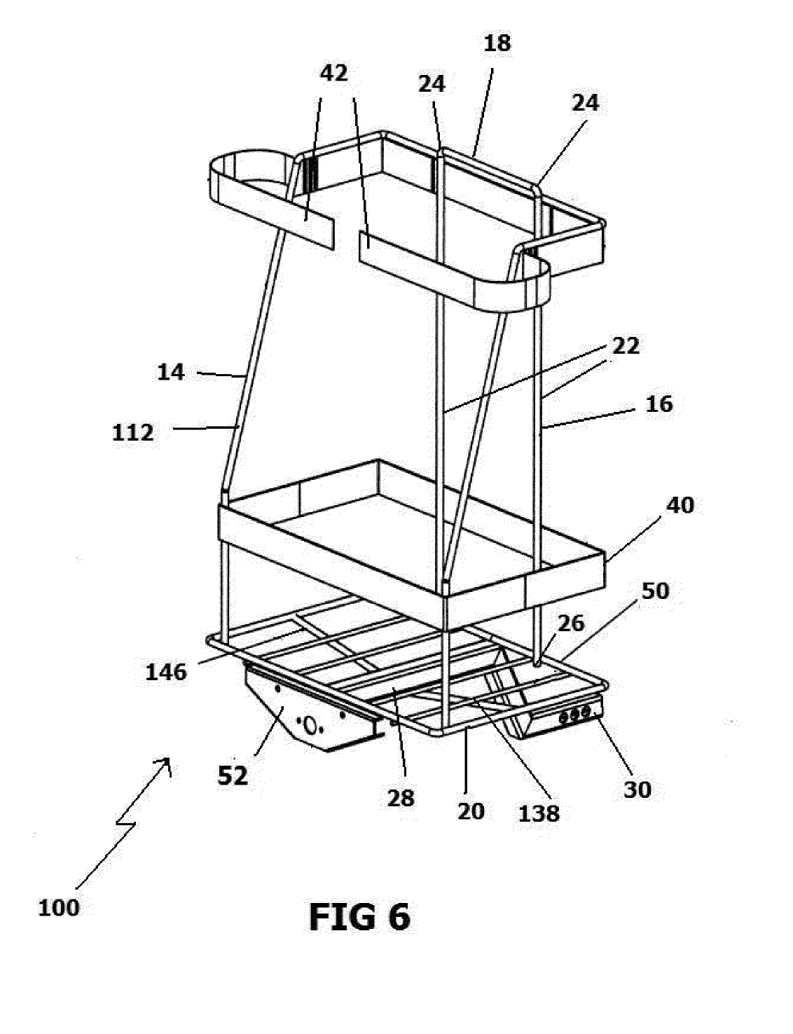

Referring to FIG. 1, as carrier 10 is supported by and detachable by means of a hitch engagement 29, it can be quickly and easily mounted to a motorcycle 36 or detached quickly as needed. Referring to FIGS. 5 and 6, in the illustrated embodiment hitch engagement 29 involves hitch 30 provided on a first end 47 of the horizontal support 28 which is inserted into the hitch receiver 32 provided on the rear 34 of a motorcycle body 36, although it will be appreciate that other types of hitching means can also be used. Referring to FIG. 5, as carrier 10 is mounted to a rear 34 of the motorcycle 36 as opposed to the sides, it will not cause unnecessary drag on the motorcycle 36 during operation, nor does it interfere with having a passenger on the motorcycle 36 or other cargo 48 such as side carrying cases (not shown) that may be mounted on the sides of the motorcycle 36.

Referring again to FIG. 1, frame 12 is preferably constructed of intersecting lightweight wires 50, however as noted previously other materials can also be used. Likewise, golf club bag support platform 38 is constructed with crossing wires 50, but could be fabricated from other types of materials as noted above. In the illustrated embodiment, wires 50 are used as they are resilient, reasonably weather proof, and have a suitable strength for holding golf bags 44 securing. Wires 50 also allow for the carrier 10 to have suitable strength without adding bulkiness or extra weight to the motorcycle 36. Furthermore, wires 50 allow for air to flow through the carrier 10 thereby limiting the amount of drag on the motorcycle 36 during operation. It is preferred that during manufacturing, wires 50 are bent and shaped so that frame 12 has smooth rounded edges so as not to scratch or catch on the contents. Ensuring that the carrier 10 is very light also allows for ease of transportation when disengaged from the motorcycle 36. One can easily remove carrier 10 and carry it to a storage facility, garage or a hotel room to prevent theft.

Referring to FIG. 3, a mounting plate 52 is provided on the front 14 of the carrier 10 to mount the license plate 54 and ensure its visibility. Mounting plate 52 can be secured to a second end 53 of horizontal support as illustrated in FIG. 3, or elsewhere on the front 14 of the carrier 10 so long as it is visible. The mounting plate 52 is provided with apertures 56 which allow for brake lights 58 and signal lights 60 to be mounted as shown in FIG. 5. FIG. 5 also illustrates a wiring harness 62 that is carried and protected within horizontal support 28.

In the illustrated embodiment, a horizontal support 28 is shown which has an upward angled portion 64 so as to ensure that carrier 10 is carried at a height that ensures adequate road clearance during travel.

### Variations

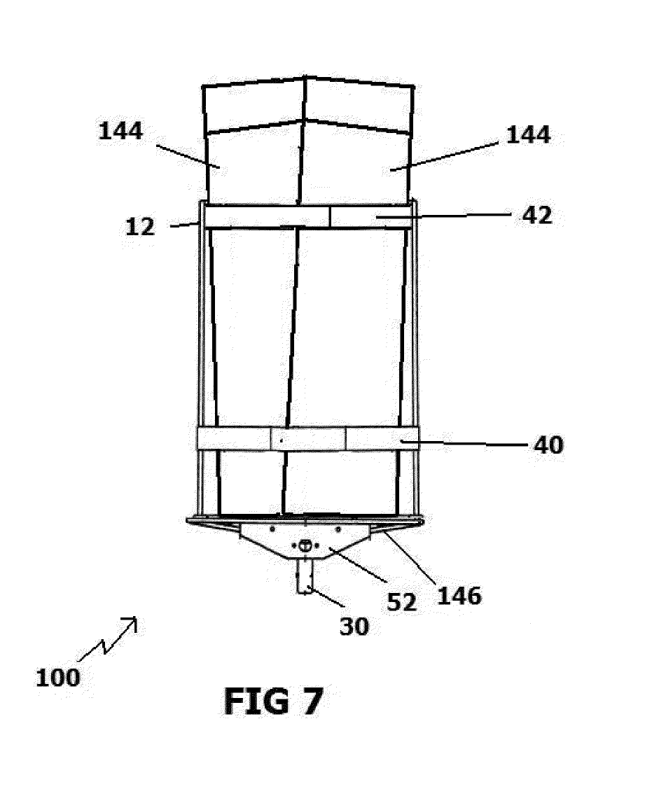

Referring to FIGS. 6 and 7, there is illustrated a golf club carrier for a motorcycle 100 which is adapted to hold two golf club bags 144. As illustrated in FIG. 6, the frame 112 and golf club bag support platform 138 are of a width to accommodate two golf club bags 144 as shown in FIG. 7. The cross support member 146 is also of a corresponding width such that the weight from the two golf club bags 144 is properly distributed and supported by the golf club bag support platform 138.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A golf club carrier for a motorcycle comprising;
a frame having a front and a back, a top and a bottom;
at least one vertical support being provided as the back, the vertical support having a first upper end and a second lower end;
at least one horizontal support extending perpendicular from the second lower end of the vertical support;
a mounting means for mounting the horizontal support to a rear of a motorcycle body;
a golf club bag support platform extending outwardly from the second lower end of the vertical support and over the horizontal support;
at least one securing means for securing a golf club bag within the frame; and
at least one cross support member secured to the golf club bag support platform and secured to and traversing the at least one horizontal support.

2. The golf club carrier for a motorcycle of claim 1, wherein the mounting means for mounting the horizontal support to a rear of a motorcycle body is a hitching engagement.

3. The golf club carrier for a motorcycle of claim 1, wherein at least one securing means for securing a golf club bag within the frame is polypropylene straps are provided on the front of the frame.

4. A method for mounting a golf club carrier to a motorcycle comprising the steps of:
providing a golf club carrier having a front and a back, a top and a bottom, at least one vertical support being provided as the back, the vertical support having a first end and a second end, at least one horizontal support extending perpendicular from the second end of the vertical support, a hitch for mounting the horizontal support to a rear of a motorcycle body, a golf club bag support platform extending outwardly from the second end of the vertical support and over the horizontal support, at least one securing means for securing a golf club bag within the frame, and at least one cross support member secured to the golf club bag support platform and secured to and traversing the at least one horizontal support; and
engaging the hitch on the horizontal support to a receiver mounted on a rear of a motorcycle body so that carrier is securely fastened to the motorcycle body.
